(19) United States
(12) Patent Application Publication
(10) Pub. No.: US 2017/0374529 A1
(43) Pub. Date: Dec. 28, 2017

(54) Speech Recognition Telecommunications System with Distributable Units

(71) Applicant: Diane Walker, Philadelphia, PA (US)

(72) Inventor: Diane Walker, Philadelphia, PA (US)

(21) Appl. No.: 15/190,835

(22) Filed: Jun. 23, 2016

(51) Int. Cl. H04W 4/04; H04W 4/00; G10L 15/22; H04M 1/725; H04L 29/08; H04W 84/12

(52) U.S. Cl. CPC H04W 4/04; H04M 1/72583; H04L 67/306; H04W 4/008; G10L 15/22; G10L 2015/223; H04W 84/12

(57) ABSTRACT

A speech recognition telecommunications system with distributable units. The system includes a primary unit and one or more secondary units, wherein the primary unit includes a processor, memory, a logic, a telecommunications transceiver configured to connect to a telecommunications network, and a secondary transceiver in communication with the secondary units. The secondary units are distributable throughout a structure and each include a transceiver, speaker, and a microphone for relaying received audio signals back to the primary unit. In operation, the primary unit receives a user's audio via its microphone or via transmission from a secondary unit. The logic then compares the user's vocal pattern to stored vocal patterns to confirm a user match. If there is a user match, then the logic compares the user's spoken command to a library of predetermined commands, wherein the processor executes the matching command from the library.

### BACKGROUND OF THE INVENTION

The present invention relates to telecommunications systems. More specifically, the present invention relates to speech recognition telecommunications system having distributable units that can be placed throughout a structure, such as a home or building, thereby enabling a user to initiate a phone call, solely utilizing vocal commands, in any room of the structure containing a unit.

Conventional cordless home phones and mobile phones are often misplaced by individuals in their homes. These misplaced telephones are often difficult to locate and may be lost for extended periods of time, which can be particularly frustrating and even dangerous to a user when wanting to make a phone call or when waiting on a phone call. Individuals who are forgetful or absent-minded, more so than others, have difficulty tracking their phones at all times. Thus, these individuals are especially prone to misplacing their telephones, thereby leading them to miss phone calls more often or preventing them from making phone calls when desired or in an emergency.

The use of voice recognition is known in the prior art. More specifically, telecommunications systems that have been devised and utilized to employ speech recognition systems are known to consist basically of familiar, expected and obvious structural configurations, notwithstanding the myriad of designs encompassed by the crowded prior art which have been developed for the fulfillment of countless objectives and requirements.

While these systems and devices fulfill their respective, particular objectives and requirements, the prior art does not describe a speech recognition system having multiple distributable units that can be placed throughout a structure, thereby enabling a user to initiate a phone call, solely utilizing vocal commands, in any room of the structure containing a unit.

In this respect, a telecommunications system having this sort of capabilities substantially departs from the conventional concepts and designs of the prior art, and in doing so provides an apparatus developed for the purpose of providing users a convenient way in which to make and receive telephone calls in their home.

Therefore, it can be appreciated that there exists a continuing need for a new and improved speech recognition telecommunications system having distributable units enabling users to make, receive, an continue a phone call in any location of a structure, such a home, office, or building merely by utilizing vocal commands.

### SUMMARY OF THE INVENTION

In view of the foregoing disadvantages inherent in the known types of telecommunications systems now present in the prior art, the present invention provides a speech recognition telecommunications system having distributable units wherein the same can be utilized for providing convenience to a user when trying to remotely initiate, receive, and carry out telephone calls and conversations in any room of a structure without the use of a headset. The present system comprises a primary unit in communication with a secondary unit, the primary unit including a telecommunications transceiver configured to connect to a telecommunications network, a secondary transceiver configured to be in communication with the secondary unit, a user interface having a housing including a display and an input, an audio input, an audio output, a processor, a memory in operative communication with the processor, a logic disposed on the memory, that when executed by the processor, causes the speech recognition system to perform a method, the method comprising the steps of receiving an audio signal via one of the audio input and the secondary unit, generating an electrical representation of a vocal pattern of the audio signal, comparing the electrical representation of the vocal pattern to an electrical representation of a stored vocal pattern, if the electrical representation of the vocal pattern and the electrical representation of the stored vocal pattern match, then comparing the audio signal to a library of commands, and if the audio signal matches a command within the library of commands, executing the command, and wherein the secondary unit includes a transceiver configured to be in communication with the secondary transceiver of the primary unit, an audio input, an audio output, wherein the secondary unit is configured to relay sound received by the audio input to the primary unit and emit sound received from the primary unit via the audio output.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a block diagram of the speech recognition telecommunications system.

FIG. 2 shows a block diagram of the primary unit of the speech recognition telecommunications system.

FIG. 3 shows a flow chart of the process by which the primary unit is programmed with a user's voice.

FIG. 4 shows a flow chart of the process by which the logic recognizes a stored user's voice and executes a command.

FIG. 5 shows a perspective view of the user interface of the primary unit.

FIG. 6 shows a block diagram of the secondary units of the speech recognition telecommunications system.

FIG. 7 shows a pictorial diagram of the secondary units distributed throughout a structure.

### DETAILED DESCRIPTION OF THE INVENTION

Reference is made herein to the attached drawings. Like reference numerals are used throughout the drawings to depict like or similar elements of the voice-activated telecommunication system. The figures are intended for representative purposes only and should not be considered to be limiting in any respect.

As used herein, “logic” refers to (i) logic implemented as computer instructions and/or data within one or more computer processes and/or (i) logic implemented in electronic circuitry. In the interests of economy, the present disclosure refers to “a processor,” and so on. However, this should not be read as limiting in any way as the present disclosure contemplates embodiments of the present invention utilizing “one or more processors,” and so on. Unless specifically limited to a single unit, “a” is intended to be equivalent to “one or more” throughout the present disclosure.

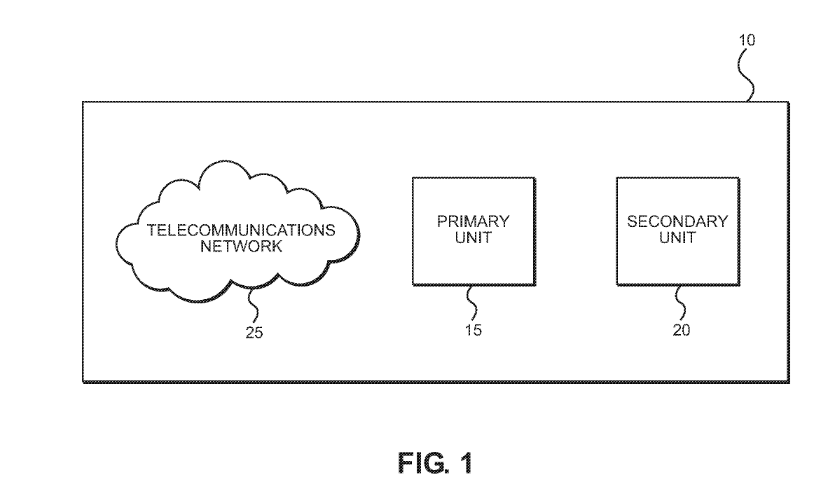

Referring now to FIG. 1, there is shown a block diagram of the speech recognition telecommunications system. The speech recognition telecommunications system 10 comprises a primary unit 15 and one or more secondary units 20 in communication with one another. The primary unit 15 is configured to connect to and communicate over a telecommunications network 25, while the secondary units 20 are configured to be distributed throughout a structure, such as a home, office, or building. The primary unit 15 and secondary units 20 each comprise a transceiver for communicating with one another. The secondary units 20 each comprises a microphone and a speaker configured to relay audio signals to the primary unit 15. In this way, the secondary units 20 enable a user to make phone calls through the primary unit 15 from anywhere in a structure.

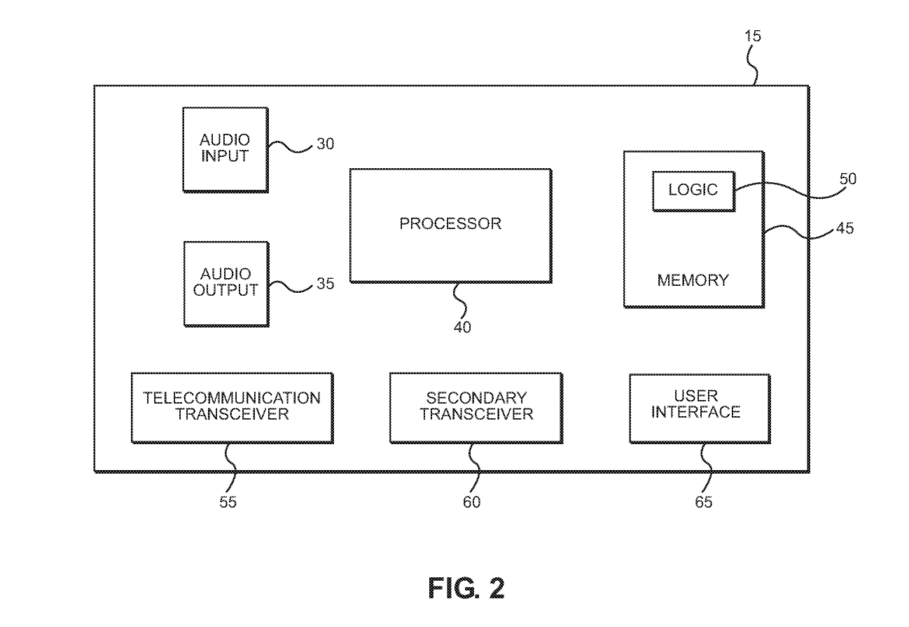

Referring now to FIG. 2, there is shown a block diagram of the primary unit of the speech recognition telecommunications system. The primary unit 15 comprises an audio input 30, an audio output 35, a processor 40, a memory 45, a logic 50, a telecommunications transceiver 55, a secondary transceiver 60, and a user interface 65 having a display and inputs. In one embodiment, the audio input 30 is a microphone and the audio output 35 is a speaker. In another embodiment, the audio input 30 and the audio output 35 are structurally a single device, such as a microphone capable of both receiving and emitting audio.

The logic 50 is stored on the memory 45 and is executed by the processor 40. The logic 50 is configured to recognize a user's speech via stored vocal patterns. The telecommunications transceiver 55 is capable of connecting the primary unit 15 to a telecommunications network via a wireless or wired connection, e.g. a cellular network, to make calls and connect to another telecommunications device. The secondary transceiver 60 is in communication with a transceiver of the secondary units and enables the primary unit and secondary units to relay audio signals back and forth between each other. In one embodiment, the secondary transceiver is in wireless communication with a transceiver of the secondary units via a wireless network, such as WiFi. In another embodiment, the secondary transceiver is in wired communication with the transceiver of the secondary units.

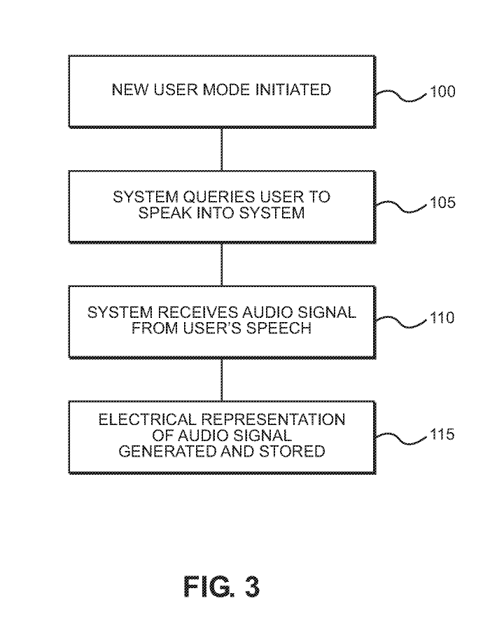

Referring now to FIG. 3, there is shown a flow chart of the process by which the primary unit is programmed with a user's voice. In order to program a voice or vocal pattern into the memory of the primary unit, a new user mode is initiated, as shown by step 100. In one embodiment, the new user mode is initiated upon activation of the speech recognition telecommunications system after its installation in a structure. In another embodiment, the new user mode is initiated via the user interface, wherein the new user mode is selected from a settings input on the user interface. After the user mode is initiated, the user interface queries the user to speak a predetermined word or phrase into the audio input of the primary unit, as shown by step 105. In one embodiment, the user interface queries a user via a dialog box on a display screen thereof. In another embodiment, the user interface queries a user through an audio question relayed by the audio output of the primary unit. After a user responds to the query by speaking into the audio input, the audio is received by the audio input, as shown by step 110. The logic then translates the audio signal into an equivalent electrical representation, such as a digital representation or analog representation, and stores the electrical representation into the memory, as shown by step 115. In one embodiment, the logic stores only one electrical representation of a vocal pattern onto the memory, wherein the new user mode is password protected, thereby restricting the speech recognition system to one user. In another embodiment, the logic stores various electrical representation of vocal patterns into the memory, thereby enabling one or more users to store their vocal patterns onto the memory, such that the speech recognition system is compatible with multiple users.

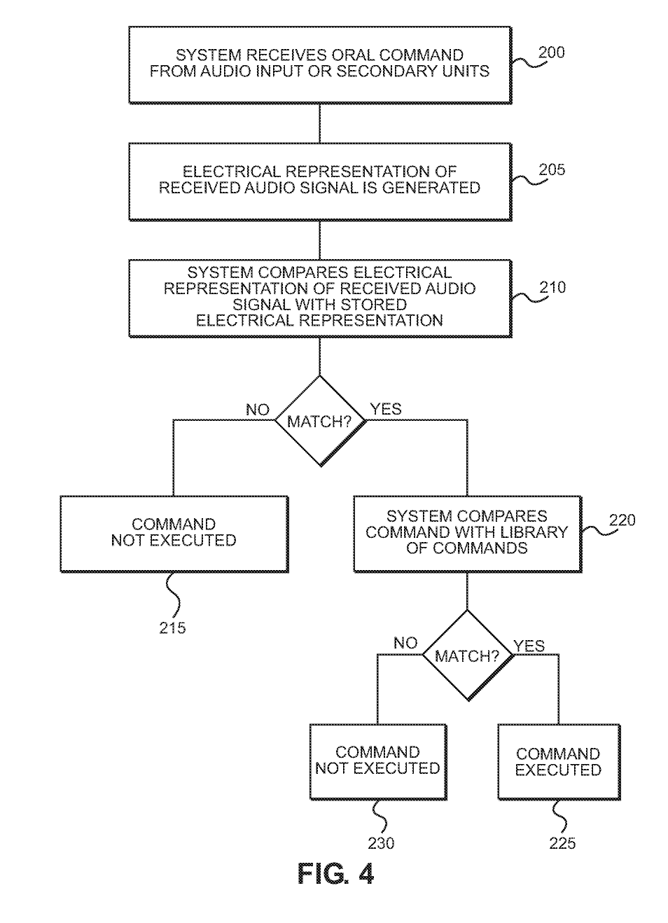

Referring now to FIG. 4, there is shown a flow chart of the process by which the logic recognizes a stored user's voice and executes a command. First, the logic receives sound or audio in the form of an oral command spoken by a user from the audio input or from the secondary units, as shown by step 200. The logic 50 then generates an electrical representation of the audio signal, as shown by step 205. The logic then compares the electrical representation of the received vocal pattern to an electrical representation of a stored vocal pattern stored in the memory, as shown by step 210. If the electrical representations do not match then the processor does not execute a command, as shown by step 215. However, if the electrical representation's match then the processor executes a command, then the logic determines what command was spoken by comparing the received audio signal to a library of commands stored in the memory, as shown by step 220. If the logic finds a match in the command library, then the logic executes the matching command, as shown by step 225. For example, if a stored user speaks a command, such as “end call,” “call mom,” or to call a certain stored contact, the logic will execute the command upon finding the matching command in the library. However, if there is no matching command in the command library, then the logic will not execute the command, as shown by step 230.

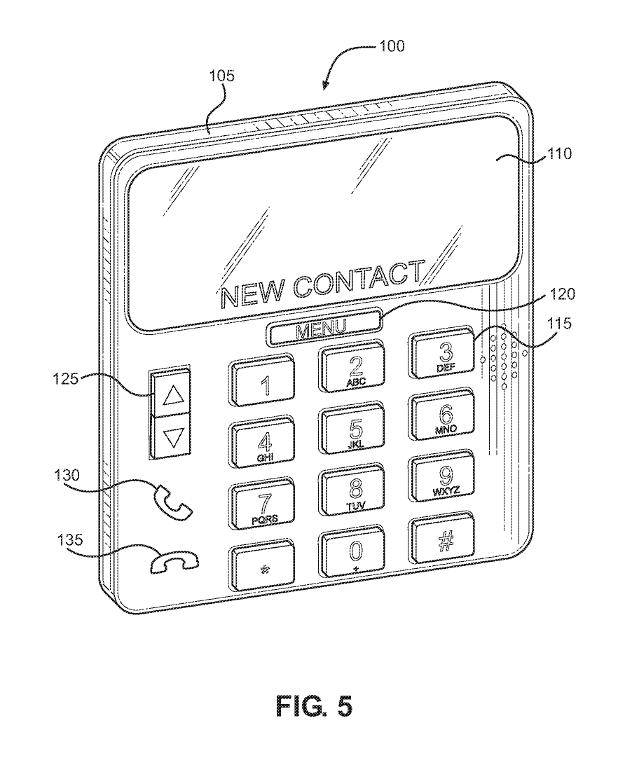

Referring now to FIG. 5, there is shown a perspective view of the user interface of the primary unit. The user interface 100 includes a housing 105 having a display screen 110 and an input for storing and entering contact information, such as an individual's name and telephone number. The housing 105 is configured to be mountable onto a wall, such as onto a wall's phone outlet. In one embodiment, the input comprises an alphanumerical keypad 115, such as the standard keypad of a conventional phone. In another embodiment, the input comprise a QWERTY keyboard. In yet another embodiment, the input further comprise a menu 120 containing a list of options including, by not limited to, contacts, recent calls, favorites, voicemail, and settings, wherein a new user mode may be selected. In other embodiments, the input further comprises a volume adjustment 125 button, a call/answer 130 button for calling or answering calls, and an end 135 button for ending telephone calls.

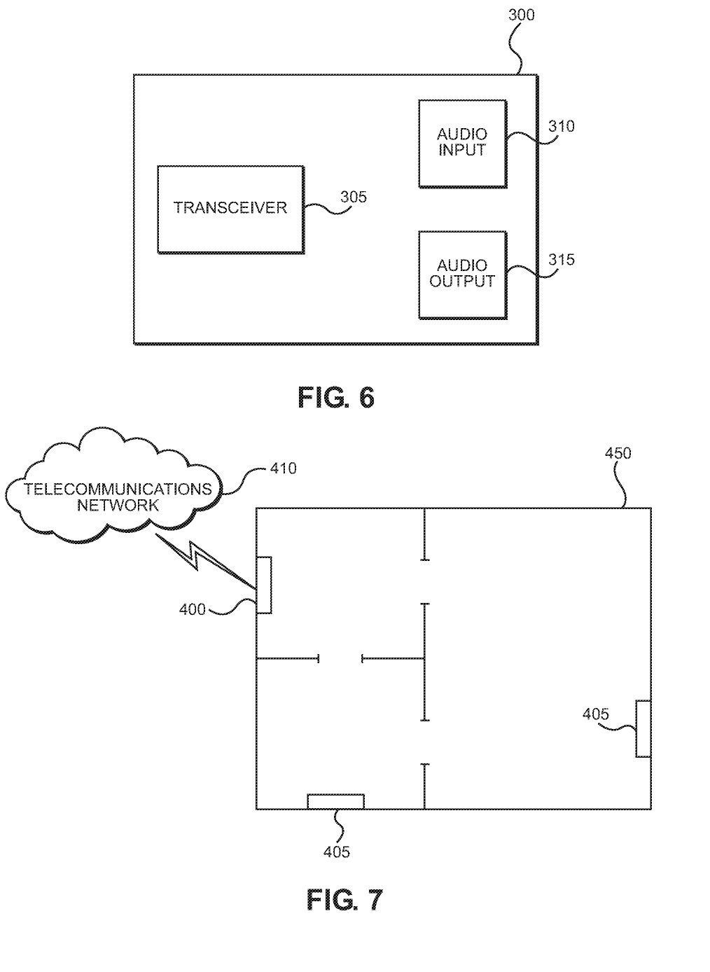

Referring now to FIG. 6, there is shown a block diagram of the secondary units of the speech recognition telecommunications system. The secondary units 300 each comprise a housing having a transceiver 305, an audio input 310, and an audio output 315, wherein each transceiver 305 is in communication with the transceiver of the primary unit, such that each secondary unit may relay received audio signals back to the primary unit as well as emit audio signals received by the primary unit. In one embodiment, the transceiver of the secondary unit is in wireless communication with the secondary transceiver of the primary unit, such as by WiFi. In another embodiment, the transceiver is in wired communication with the secondary transceiver. In one embodiment, the audio input is a microphone and the audio output is a speaker. In a second embodiment, the audio input and the audio output are structurally a single device, such as a microphone capable of both receiving and emitting audio. The housing of the secondary units are each capable of being mounted to a wall and are configured to be distributed throughout a structure.

Referring now to FIG. 7, there is shown a pictorial diagram of the secondary units distributed throughout a structure. In one use, the primary unit 400 is configured to be installed in one area of a home 450, such as the kitchen or family room. The secondary units 405, on the other hand, are configured to be installed or mounted in other, more remote rooms of the home, such as the basement, laundry room, and/or spare bedrooms, such that they are in areas in which the primary unit 400 is not. The distribution of secondary units 405 throughout a structure enables a user to make calls over the telecommunications network 410 via the primary unit 400 in each room in which a secondary unit 405 has been installed. Further, it enables a user to carry out a conversation throughout the entire structure without needing a headset. Overall, the secondary units 405 enable a user to communicate with a caller over the telecommunications network 410 via the primary unit 405 in remote locations of a home or building without a headset and without having to be in close proximity to the primary unit 400.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1) A speech recognition telecommunications system, comprising:
a primary unit in communication with a secondary unit, the primary unit and the secondary unit configured to be mounted onto a structure, the primary unit comprising a telecommunications transceiver configured to connect to a telecommunications network, a secondary transceiver configured to be in communication with the secondary unit, a user interface having a housing including a display and an input, an audio input configured to receive audio, an audio output configured to emit audio, a processor, a memory in operative communication with the processor, and a logic disposed on the memory;
the secondary unit comprising a transceiver in communication with the secondary transceiver of the primary unit, an audio input configured to receive audio, and an audio output configured to emit audio;
wherein the transceiver of the secondary unit is configured to relay audio received by the audio input of the secondary unit to the secondary transceiver of the primary unit;
wherein the secondary transceiver of the primary unit is configured to relay audio received by the audio input of the primary unit to the transceiver of the secondary unit;
wherein the audio output of the primary unit is configured to emit audio received from the transceiver of the secondary unit;
wherein the audio output of the secondary unit is configured to emit audio received by the secondary transceiver of the primary unit;
wherein the logic, when executed by the processor, causes the speech recognition system to perform a method, the method comprising the steps of:
receiving an audio signal via one of the audio input of the primary unit and the audio input of the secondary unit;
generating an electrical representation of a vocal pattern of the audio signal;
comparing the electrical representation of the vocal pattern to an electrical representation of a stored vocal pattern;
if the electrical representation of the vocal pattern and the electrical representation of the stored vocal pattern match, then comparing the audio signal to a library of commands; and
if the audio signal matches a command within the library of commands, executing the command.

2) The speech recognition telecommunications system of claim 1, wherein the audio input is a microphone.

3) The speech recognition telecommunications system of claim 1, wherein the audio output is a speaker.

4) The speech recognition telecommunications system of claim 1, wherein the input of the user interface comprises an alphanumeric keypad.

5) The speech recognition telecommunications system of claim 4, wherein the input further comprises a menu containing a list of options, the list of options selected from a group consisting of contacts, recent calls, favorites, voicemail, and settings.

6) The speech recognition telecommunications system of claim 5, wherein the input further comprise a volume adjustment.

7) The speech recognition telecommunications system of claim 1, wherein the transceiver of the secondary unit is in wireless communication with the secondary transceiver of the primary unit via WiFi.

8) The speech recognition telecommunications system of claim 1, wherein the transceiver of the secondary unit is in wireless communication with the secondary transceiver of the primary unit via Bluetooth.
